(19) United States
(12) Patent Application Publication
(10) Pub. No.: US 2011/0183823 A1
(43) Pub. Date: Jul. 28, 2011

(54) FREE-STANDING EXERCISE APPARATUS

(76) Inventor: James Priday, Devon (GB)

(21) Appl. No.: 13/012,111

(22) Filed: Jan. 24, 2011

(30) Foreign Application Priority Data
Jan. 22, 2010 (GB) GB1000997.5

(51) Int. Cl. A63B 21/00; B23P 17/04

(52) U.S. Cl. 482/131; 29/428

(57) ABSTRACT

A free-standing exercise apparatus is provided which comprises a base, at least one leg extending, in use, upwardly from the base, and a substantially horizontal bar attached to the at least one leg at an end substantially opposite to the base, wherein the bar has a substantially rectilinear first portion and at least one second portion arranged substantially in the same plane as, but substantially non-perpendicularly to, the first portion.

### CROSS-REFERENCE TO RELATED APPLICATION

The present non-provisional patent application claims the benefit of priority of foreign Patent Application No. GB1000997.5 which is entitled A FREE-STANDING EXERCISE APPARATUS and which was filed Jan. 22, 2010, which is incorporated in full by reference herein.

### FIELD OF THE INVENTION

The present invention relates generally to a free-standing exercise apparatus, a method of assembly of said apparatus and to a method of exercise using said apparatus and finds particular, although not exclusive, utility in improving a user's fitness.

### BACKGROUND OF THE INVENTION

Free standing exercise apparatus are useful for exercising in both domestic situations and gymnasia. Exercise apparatus which allows a user to pull themselves upwardly away from the floor are typically substantially attached in some way to the fabric of a building, or to the floor, or require to be braced against part of a building such as in a door way. However, free-standing apparatus does not require any such attachment or bracing which means it is more easily installed and allows it to be moved as required.

Such apparatus may also be capable of disassembly for ease of transport and may therefore be portable.

One such exercise apparatus is described in GB-A-2393919. However, the apparatus is relatively heavy and bulky and comprises separate members which have to be attached together using standard nuts and bolts. In other words, the apparatus has to be put together by selection of the appropriate adjacent members. Moreover, the apparatus provides limited positions for a user's hands to grip in use. It would be desirable therefore to provide an alternative apparatus which offers improved assembly/disassembly and the possibility of different hand gripping positions.

### BRIEF SUMMARY OF THE INVENTION

In one aspect, the invention provides a free-standing exercise apparatus comprising a base, at least one leg extending, in use, upwardly from the base, and an upper gripping member attached to the at least one leg at an end substantially opposite to the base, wherein the upper gripping member comprises a substantially horizontal and rectilinear first portion, two second portions arranged substantially in the same plane as, but substantially non-perpendicular to, the first portion, and a third portion arranged substantially in the same plane as, and substantially perpendicular to, the first portion, wherein the two second portions are arranged either side of the third portion forming a triangular shape, with the first portion, in the said plane.

In one embodiment, the apparatus may be assembled such that the upper gripping member is above a user's head when the user stands adjacent it such that the user may use the apparatus to pull themselves up. Alternatively, the apparatus may be assembled such that the upper gripping member is substantially at chest height when the user stand adjacent it. Alternatively, the apparatus may be at assembled such that the upper gripping member is at waist height so that a user may push themselves upwardly. Other intermediate positions are also possible for the height of the upper gripping member relative to the base.

The arrangement of the first and second portions allows a user to grip one portion with each hand, in use, such that the user's hands are oriented at differing angles within the said plane. This may provide a more comfortable experience for the user and allows for different muscle groups to be worked compared to a situation where the user's hands are substantially in line with one another along a rectilinear bar. In this respect, the at least one second portion may be arranged such that it is not parallel to the first portion.

The first, second and third portions may be tubular, although other shapes are contemplated.

The base may include at least one telescopically extendable foot. This allows the area of the base to be adjusted as required. More than one foot may also be provided, such as two feet. The telescopic nature of the foot also allows for the apparatus to be packed into a relatively small volume when disassembled. The foot may be of square-section, although other shapes are contemplated.

The second portion may be connected to the first and third portions. This connection may be at each end of the second portion. In this way a triangle of portions lying substantially in the same plane as each other may be provided. This allows more hand gripping positions and combinations thereof.

There are three triangles provided with the arrangement of the first, second and third portions; one arranged on one side of the third portion and formed by the first, second and third portions, one arranged on the other side of the third portion and formed by the first, other second, and third portions, and one formed by the first and two second portions. This provides even more versatility and allows a user to grip the gripping member with each hand at a multitude of angles and also allows the user to position their body at differing angles relative to the apparatus. This allows for more muscle groups to be worked than has hithertofore been possible.

The free-standing exercise apparatus may include more than one arrangement of second and third portions at differing locations along the length of the first portion. In this way, another one to three triangular shape portions may be provided at least at one other location along the length of the first portion.

The gripping member may include a carrying handle. This permits the apparatus to be portable when disassembled. In one sense therefore the apparatus is portable.

The first portion may include at least one fourth substantially rectilinear portion arranged at one end and extending out of the plane in which the first portion substantially lies. This portion may also be tubular. It may extend downwardly towards the base. Alternatively, it may extend upwardly. Two fourth portions may be provided one at each end of the first member. They may both extend downwardly or upwardly or in substantially opposite directions.

The gripping member may be removably attachable to the apparatus and may be arranged to accept weights for the purpose of using it as a bar bell. This allows greater versatility for the user and obviates the need for a separate bar bell for the purpose of weight lifting.

The free-standing exercise apparatus may include resiliently biased bolts (or “pull-pins”) for adjustably maintaining the position of at least some of the base, leg and upper gripping member in relation to one another. These resiliently biased bolts may include springs which bias the bolts to an extended or retracted position. Such bolts may have to be manually pulled, pushed or twisted to overcome the biasing force such that they can be moved to the retracted or extended position to allow movement between the various members comprising the apparatus. One or more such bolts may include means, such as cotter pins, for locking the bolts in the extended or retracted position such that free movement of two or more members is possible. These bolts allow for relatively quick assembly and disassembly and obviate the need for tools such as spanners etc. In at least this sense, the free-standing exercise apparatus may include quick-release bolts for allowing the apparatus to be assembled and disassembled relatively easily and substantially without the need for tools.

In one embodiment, each of the adjacent members comprising the apparatus, apart from possibly the gripping member, remain linked to one another so that assembly is relatively easy in that the assembler does not have to select the correct members from a multitude of members. The link between members may be effected by hinges or pivots in the case of the feet and leg members. The link may be the telescopic nature of the feet members (front and rear members), and they may contain means for preventing the two portions from being completely separated. The leg members (upper and lower members) may also comprise such features to prevent their complete separation. In this way, the apparatus may be “un-folded”.

In a second aspect, the invention provides a method of assembly of a free-standing exercise apparatus comprising the steps of providing a free-standing exercise apparatus according to the first aspect and as described and/or claimed herein, arranging the base on a surface, moving the at least one leg such that its length is substantially perpendicular to the base, and attaching the gripping member to the upper end of the leg.

The locking of the various members relative to one another to prevent movement therebetween in use may be effected by means of resilient biased bolts although other means are contemplated.

The at least one leg of the free-standing exercise device may be telescopic, and the method may further comprise the step of extending the length of the leg as required.

The apparatus may include two legs and the length of each may be adjustable independently. This allows for the apparatus to be assembled on an uneven surface.

The base of the free-standing exercise apparatus may include two feet each telescopically extendable, and the method may further comprise the step of extending the length of each foot as required.

The free-standing exercise apparatus may include two legs and adjustable bracing therebetween, and the method may further comprise the step of bracing the two legs apart to substantially fix their positions relative to one another.

The bracing may comprise two struts each pivotably connected at one end to each leg and pivotably coupled together at their other ends. A movable locking member may be provided to substantially fix the position of the two struts relative to one another. The pivotable connection allows the struts to move relative to the legs during disassembly thereby allowing the two legs to move close to one another thus effecting a small volume when “packed” and disassembled.

In a third aspect, the invention provides a method of exercise comprising the steps of providing a free-standing exercise apparatus according to the first aspect and as described and/or claimed herein, wherein the at least one leg of the free-standing exercise apparatus is telescopic, attaching at least one weight to the gripping member, and moving the gripping member upwardly and downwardly relative to the base such that the at least one leg extends and contracts telescopically.

In this way the gripping member is guided as it travels upwardly and downwardly. This provides a safer environment as the user does not need to be concerned if the gripping member is released as it will not hit the floor or the user.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is an elevational view of the apparatus in an assembled form with the legs extended;

FIG. 2 is an elevational view of the apparatus in an assembled form with the legs retracted; and

FIG. 3 is a perspective view of the apparatus in a disassembled and packed state.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may refer to different embodiments. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

The invention will now be described by a detailed description of several embodiments of the invention. It is clear that other embodiments of the invention can from the true spirit or technical teaching of the invention, the invention being limited only by the terms of the appended claims.

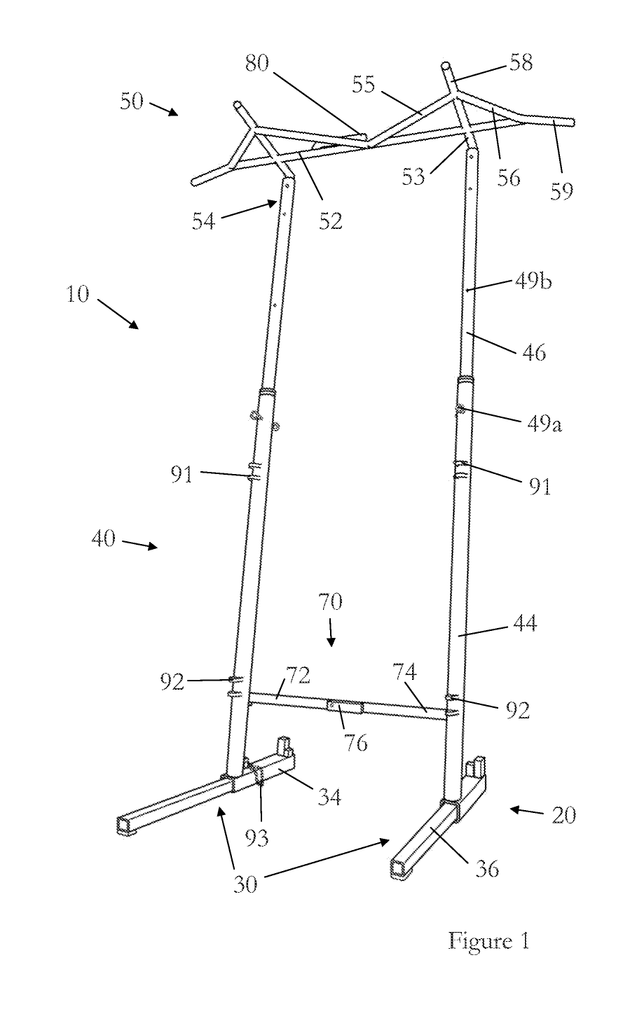

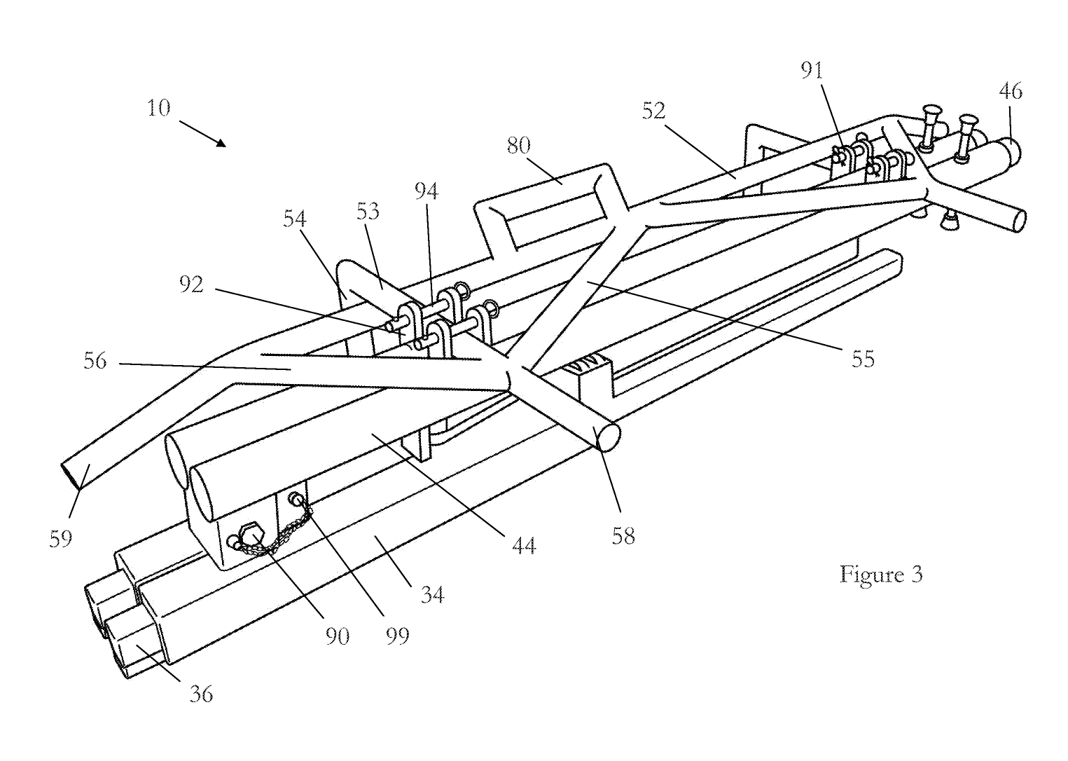

In FIG. 1, the assembled and erected apparatus 10 comprises a base 20. This base 20 comprises two feet 30, one at the lower end of each leg 40. Each foot comprises a rectilinear length of box-section section. Each foot 30 comprises a rear 34 and a front 36 member. The front member 36 has a smaller cross-section than the rear member 34 such that it may be moved telescopically into and out of the larger rear member 34. This allows the length of the feet 30 to be adjusted as required and allows the apparatus to be packed into a small volume as may be seen in FIG. 3. The position of the two members 34, 36 of each foot 30 relative to one another may be adjustably fixed by means of a pin (not shown), attached to the rear member 34 by means of a chain 93, passing through a hole in each member 34, 36, the hole selected from a plurality of holes for the appropriate length as required. Other means of adjustably maintaining the relative positions of the two feet members 34, 36 are contemplated such as the pull-pins discussed above.

Each leg 40 comprises two members 44, 46 of generally tubular shape. The lower leg 44 has a larger cross-section than the upper leg 46 such that the upper leg 46 may be moved telescopically into and out of the larger lower leg 44. This allows the length of the legs 40 to be individually adjusted to cater for uneven ground and for adjustment of the height of the upper gripping member 50 relative to the base 20. It also allows the apparatus to be packed into a small volume as may be seen in FIG. 3.

The upper 46 and lower 44 leg members are retained in position relative to one another by means of bolts 49a provided at the upper end of the lower leg members 44. Corresponding holes 49b are provided in the upper leg members 46 at various positions along their lengths to allow positive locking of the bolts 49a therein. Other means of adjustably maintaining the relative positions of the upper 46 and lower 44 leg members are contemplated such as the pull-pins discussed above.

Each leg 40 may be releasably attached to each foot 30. Alternatively, or additionally, each leg 40 may be pivotable connected to each foot 30.

Slots 91, 92 are provided on each lower leg member 44. These will be described in more detail in conjunction with the discussion regard FIG. 3 below.

The upper gripping member 50 is provided at the upper end of the legs 40. It comprises a first portion 52 which is substantially rectilinear and horizontally positioned. The first portion includes downwardly depending portions which fit inside the upper end of each upper leg member 46. The position of these downwardly depending portions are indicated by reference numeral “54”. These portions 54 may be locked to the upper leg members 46 by use of bolts similar to the ones describe above and referenced “49a”. However, other means of releasably maintaining the upper gripping means 50 to the upper leg members 46 are contemplated such as the pull-pins discussed above.

From the upper end of each downwardly depending portion 54 a portion 53 extends substantially horizontally. It is to these horizontal sections 53 that the first portion 52 is attached. The first portion 52 extends over the top of both legs 40 and projects beyond the area defined by the base 20.

Two second portions 55 are connected to the middle of the length of the first portion and each extends towards a leg 40 such that they extend in different directions to one another. Each second portion 55 extends to the same side of the first portion 52. Each second portion 55 lies in the same plane as the first portion 52, but not parallel to it. Each second portion 55 makes a “V” shape arrangement with the first portion 52.

A third portion 58 extends from the end of each horizontal portion 53 in the same direction thereas. Each third portion 58 connects the end of each second portion 55, opposite from the end which is connected to the first portion 52, to the first portion 52, to form a triangular shape therebetween. Each third portion 58 extends beyond the end of each second portion 55 to provide another position for gripping by the user in use.

An additional second portion 56 is also provided substantially above each leg 40. These additional second portions 56 connect to each end of the first portion 52 at one end and to each of the third portions 58 at their other end in the vicinity where the second portions 55 connect to each third portions 58. This arrangement provides a triangular shape therebetween.

The additional second portions 56 also lie in the same plane as the first 52 and second 55 portions.

A fourth portion 59 is also provided at each end of the first portion 52. These fourth portions are not in the same plane as the first, second and third portions. Rather, they depend downwardly.

The arrangement of various portions allows a user to grip the upper gripping member 50 in numerous ways.

A handle 80 is included at one point along the length of the first portion 52 as will be described in more detail below.

The various portions may be integral with one another in that they may be manufactured from one piece. Alternatively, one or more various portions may be attached or connected together, such as by welding.

The apparatus 10 may comprise steel and/or aluminium, although other materials are contemplated.

To provide greater stability to the apparatus 10 a brace 70 is provided between the legs 40. This brace 70 comprises two struts 72, 74 which are each connected at one end to each of the lower leg members 44. The two struts 72, 74 lie substantially horizontally, in this assembled state shown, and meet in the middle between the two legs 40. The two struts are hinged or pivoted together. A locking means 76 in the form of a channel is located at this mid-point to prevent the two struts 72, 74 from moving relative to one another. The locking means 76 may be moved to allow the struts 72, 74 to pivot relative to one another during disassembly.

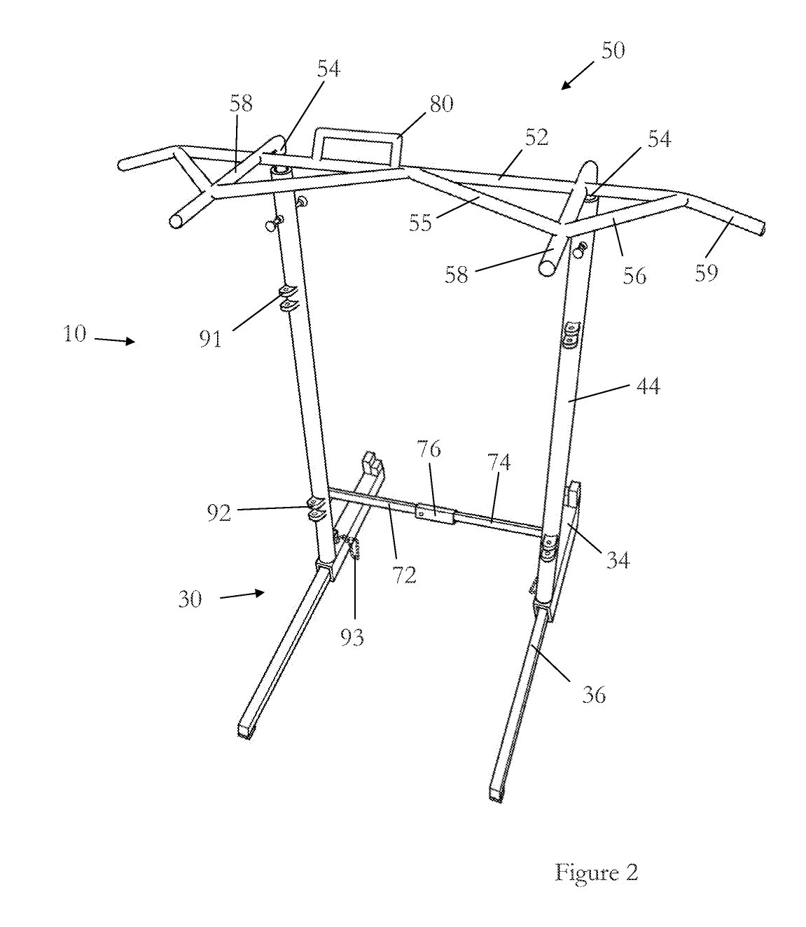

FIG. 2 shows the apparatus 10 with the upper leg members 46 retracted fully inside the lower leg members 44. A handle 80 is shown attached to the upper gripping member 50 for use as a carrying handle when the apparatus is disassembled and packed as shown in FIG. 3. All other referenced elements are the same as described with reference to FIG. 1.

FIG. 3 demonstrates how the apparatus 10 may be packed into a relatively small volume for ease of storage and or portability.

The upper gripping member 50 is attached to the lower leg members 44, which have the upper leg members 46 substantially fully retracted inside. The lower leg members 44 are, in turn, attached to the rear feet members 34, which have the forward members 36 fully retracted inside them. The legs 40 have been brought together and the feet 30 have been rotated relative to the legs (by means of pivoting means 90) such that the longitudinal axes of the feet 30, legs 40 and first portion 52 of the upper gripping member 50 are substantially parallel and adjacent with one another. The legs 40 may be releasably fixed in this position, relative to the feet 30, by use of a locking means, such as one or more pins 99 passing through appropriate holes in the pivoting means 90. The upper gripping member 50 is attached to the lower leg members 44 by means of the slots 91, 92 provided on the surface of the lower leg members 44. The two third portions 58 each fit inside the slots 91, 92 and are retained therein by means of a releasable pin 94.

What is claimed is:

1. A free-standing exercise apparatus comprising a base, at least one leg extending, in use, upwardly from the base, and an upper gripping member attached to the at least one leg at an end substantially opposite to the base, wherein the upper gripping member comprises a substantially horizontal and rectilinear first portion, two second portions arranged substantially in the same plane as, but substantially non-perpendicular to, the first portion, and a third portion arranged substantially in the same plane as, and substantially perpendicular to, the first portion, wherein the two second portions are arranged either side of the third portion forming a triangular shape, with the first portion, in the said plane.

2. The free-standing exercise apparatus of claim 1, wherein the base includes at least one telescopically extendable foot.

3. The free-standing exercise apparatus of claim 1 wherein at least one of the second portions is connected to the first and third portions.

4. The free-standing exercise apparatus of claim 1, wherein the gripping member includes a carrying handle.

5. The free-standing exercise apparatus of claim 1, wherein the first portion includes at least one fourth substantially rectilinear portion arranged at one end and extending out of the plane in which the longitudinal length of the first portion substantially lies.

6. The free-standing exercise apparatus of claim 1, wherein the gripping member is removably attachable to the apparatus and is arranged to accept weights for the purpose of using it as a bar bell.

7. The free-standing exercise apparatus of claim 1, including resiliently biased bolts for adjustably maintaining the position of at least some of the base, leg and bar in relation to one another.

8. The free-standing exercise apparatus of claim 1, including quick-release bolts for allowing the apparatus to be assembled and disassembled relatively easily and substantially without the need for tools.

9. A method of assembly of a free-standing exercise apparatus comprising the steps of providing a free-standing exercise apparatus according to claim 1, arranging the base on a surface, moving the at least one leg such that its length is substantially perpendicular to the base, and attaching the gripping member to the upper end of the leg.

10. The method of claim 9, wherein the at least one leg of the free-standing exercise device is telescopic, the method further comprising the step of extending the length of the leg as required.

11. The method of claim 9, wherein the base of the free-standing exercise apparatus includes two feet each telescopically extendable, the method further comprising the step of extending the length of each foot as required.

12. The method of claim 11, wherein the free-standing exercise apparatus includes two legs and adjustable bracing therebetween, the method further comprising the step of bracing the two legs apart to substantially fix their positions relative to one another.

13. A method of exercise comprising the steps of providing a free-standing exercise apparatus according to claim 1, wherein the at least one leg of the free-standing exercise apparatus is telescopic, attaching at least one weight to the gripping member, and moving the gripping member upwardly and downwardly relative to the base such that the at least one leg extends and contracts telescopically.
